(19) United States
(12) Patent Application Publication
(10) Pub. No.: US 2013/0337120 A1
(43) Pub. Date: Dec. 19, 2013

(54) Atmospheric Water Generator and Beverage Making Apparatus

(71) Applicant: Feliciano S. Sabates, III, Fort Lauderdale, FL (US)

(72) Inventor: Feliciano S. Sabates, III, Fort Lauderdale, FL (US)

(21) Appl. No.: 13/918,330

(22) Filed: Jun. 14, 2013

Related U.S. Application Data
(60) Provisional application No. 61/659,844, filed on Jun. 14, 2012.

(51) Int. Cl. A47J 31/44

(52) U.S. Cl. CPC A47J 31/4403
USPC 426/231; 99/279; 99/280

(57) ABSTRACT

An atmospheric water generator and coffee maker includes a coffee maker that receives water generated by a water-generating module and makes coffee out of-the water. A user interface enables a user to specify a volume of water to be generated by the water-generating module within a user-specified time period. A controller is in communication with the user interface and with the water-generating module. The controller controls a rate at which the water-generating module generates water based on the user-specified volume of water and the user-specified time period.

### CROSS-REFERENCE TO RELATED APPLICATIONS

This application claims priority to U.S. Provisional Patent Application Ser. No. 61/659,844, entitled “Atmospheric Water Generator and Coffee Maker,” which was filed on Jun. 14, 2012, the disclosure of which is incorporated herein by reference in its entirety.

### FIELD OF THE INVENTION

The present invention relates to a condenser. More specifically, the invention relates to an apparatus to condense water and create a consumable beverage.

### BACKGROUND

An atmospheric water generator may operate similarly to a dehumidifier. Air is blown over a cooled coil, causing water in the air to condense on the coil. The rate of water production may depend on ambient air temperature, humidity level, the rate at which air passes over the coil, and the machine's capacity for cooling the coil. These systems reduce air temperature around the coil, which in turn decreases the air's ability to hold water vapor.

In a cooling condensation type of atmospheric water generator, a compressor circulates refrigerant through a condenser and then through an evaporator coil which absorbs heat from the air surrounding the coil. Thus, the air temperature is lowered to its dew point, and the water condenses. A fan blows air over the coil, and the collected water is passed into a container. The rate at which water is produced may depend upon the relative humidity, ambient air temperature, and size or speed of the compressor.

What is needed is an atmospheric water generator that supplies water to a coffee maker. What is needed is an apparatus that a user may control the rate at which the water generator produces water so that a desired amount of water that is needed for coffee is produced within a given time period.

### SUMMARY

The invention is directed to an atmospheric water generator that supplies water to a coffee maker. The user may control the rate at which the water generator produces water so that a desired amount of water that is needed for coffee is produced within a given time period.

According to an embodiment of the present invention, a water condensing apparatus is provided for making a beverage. The apparatus may include a water-generating module comprising a compressor and an evaporator to generate the water from atmospheric moisture via condensation. The apparatus may include a beverage-making module configured to receive the water and make the beverage. The apparatus may include a user interface enabling a user to specify a volume of water to be generated by the water-generating module within a period that is specifiable. The apparatus may include a controller in communication with the user interface and with the water generating-module, the controller being configured to control a rate of water generation based on the volume and the period specified using the user interface. The apparatus may include a housing to at least partially enclose the water-generating module, beverage-making module, and the controller.

In another aspect, the water-generating module further includes a fan to move air across the evaporator, the air being condensed to generate the water, wherein the fan is controllable by the controller.

In another aspect, the water generated by the water-generating module is held in a tank operatively connected to the beverage-making module by a valve configurable between an open state allowing the water to be received by the beverage-making module and a closed state substantially preventing the water from being received by the beverage-making module.

In another aspect, the tank further includes a water level sensor to monitor a level of water in the tank.

In another aspect, the controller further includes a timer and is in communication with the beverage-making module, wherein the controller analyzes signals from the timer and the water level sensor to control operation of the water-generating module and the beverage-making module.

In another aspect, the controller receives a time to start making the beverage from the user interface, wherein the controller calculates the period to operate the water-generating module to generate the volume of the water needed to make the beverage at the time minus the level of the water in the tank, and wherein the controller initiates operation of the water-generating module at a start time of approximately the time minus the period.

According to an embodiment of the present invention, an apparatus is provided for making a beverage. The apparatus may include a water-generating module to generate water from atmospheric moisture. The apparatus may include a beverage-making module configured to receive the water and make the beverage The apparatus may include a user interface enabling a user to specify a volume of the water to be generated by the water-generating module within a period that is specifiable. The apparatus may include a controller in communication with the user interface and with the water generating-module, the controller being configured to control a rate of water generation based on the volume and the period specified using the user interface.

In another aspect, the water generated by the water-generating module is held in a tank operatively connected to the beverage-making module by a valve configurable between an open state allowing the water to be received by the beverage-making module and a closed state substantially preventing the water from being received by the beverage-making module.

In another aspect, the tank further includes a water level sensor to monitor a level of the water in the tank.

In another aspect, the controller further includes a timer and is in communication with the beverage-making module, wherein the controller analyzes signals from the timer and the water level sensor to control operation of the water-generating module and the beverage-making module.

In another aspect, the water-generating module further includes a compressor and an evaporator to generate the water via condensation.

In another aspect, the water-generating module further includes a fan to move air across the evaporator, the air being condensed to generate the water, wherein the fan is controllable by the controller.

In another aspect, the controller receives a time to start making the beverage from the user interface, wherein the controller calculates the period to operate the water-generating module to generate the volume of the water needed to make the beverage at the time minus the level of the water in the tank, and wherein the controller initiates operation of the water-generating module at a start time of approximately the time minus the period.

In another aspect, the apparatus further includes a housing to at least partially enclose the water-generating module, beverage making module, and the controller.

A method aspect is provided for making a beverage using a water condensing apparatus. The method may include a) specifying a volume of water usable to make the beverage to be generated by a water-generating module within a period using a user interface; b) controlling the water-generating module using a controller to generate the water; c) condensing atmospheric moisture into the water using the water-generating module; d) receiving the water by a beverage-making module from the water-generating module; and e) controlling the beverage-making module using the controller to make the beverage. The controller is in communication with the user interface, water-generating module, and beverage-making module.

In another aspect of the method, the controller is configurable to control a rate of water generation based on the volume and the period specified using the user interface.

In another aspect of the method, the apparatus includes a housing to at least partially enclose the water-generating module, beverage-making module, and the controller.

In another aspect of the method,
the water-generating module includes a compressor and an evaporator to generate water from atmospheric moisture via condensation.

In another aspect of the method, the water-generating module further includes a fan that is controllable by the controller, and wherein step (c) further includes (i) moving air across the evaporator using the fan, the air being condensed to generate the water.

In another aspect of the method, the water generated by the water-generating module is held in a tank operatively connected to the beverage-making module by a valve configurable between an open state allowing the water to be received by the beverage-making module and a closed state substantially preventing the water from being received by the beverage-making module.

In another aspect of the method, the tank further includes a water level sensor to monitor a level of water in the tank.

In another aspect of the method, the controller further includes a timer and is in communication with the beverage-making module. In this aspect, step (b) further includes (ii) analyzing a signals from the timer and the water level sensor using the controller to control operation of the water-generating module; and (iii) analyzing a signals from the timer and the water level sensor using the controller to control operation of the beverage-making module.

In another aspect of the method, the controller further includes a timer and is in communication with the beverage-making module. In this aspect, step (b) further includes (iv) receiving a time by the controller to start making the beverage from the user interface; (v) calculating the period by the controller to operate the water-generating module to generate the volume of the water needed to make the beverage at the time; (vi) calculating a start time to be a difference between the time and the period; (vii) initiating operation of the water-generating module by the controller at approximately the start time.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a combination water generator and coffee maker according to an embodiment of the present invention.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides an atmospheric water generator that supplies water to a coffee maker or other beverage making apparatus. Throughout this disclosure, the apparatus of the present invention will be discussed in the context of brewing coffee in the interest of clearly describing one embodiment of the invention. Skilled artisans should appreciate that description of such uses should not be viewed to limit the invention in any way. Additionally, having the benefit of this disclosures, skilled artisans will appreciate that the present invention may additionally be used to make teas, hot cocoa, cappuccino, chai, espresso, and other hot water based beverages. The user may control the rate at which the water generator produces water so that a desired amount of water that is needed for coffee is produced within a given period of time.

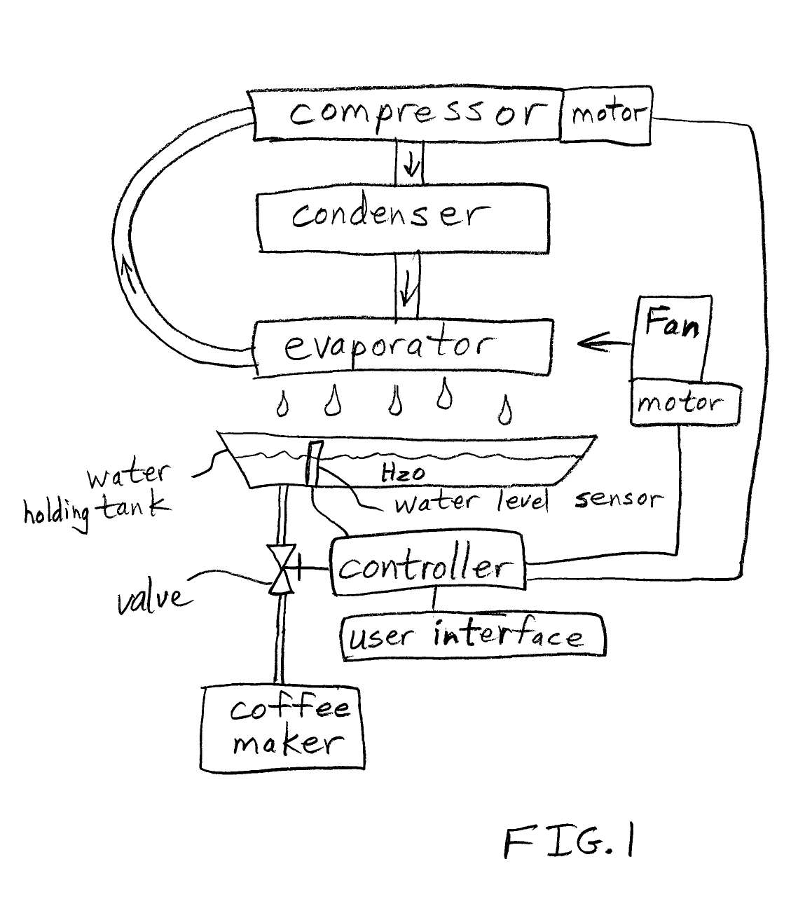

Referring now to FIG. 1, there is illustrated one embodiment of an atmospheric water generator and coffee maker of the present invention including an evaporator that condenses moisture in the air which is blown thereover by absorbing heat from the air. As the air cools, water droplets are formed on the evaporator coils and fall into a water holding tank. The warmer air being blown over the coils causes heat exchanger fluid (e.g., refrigerant) within coils of the evaporator to evaporate into a gas.

Coils of the evaporator may fluidly communicate in series with a condenser which condenses the heat exchanger fluid therein. A motor-driven compressor compresses the heat exchanger gas before circulating the heat exchanger fluid through the evaporator and condenser. The above described operation may be generally according to conventional refrigeration methods, or may be replaced by other conventional refrigeration methods. The housing containing the above components also contains a motor-driven fan which blows and circulates air through the housing, including over the evaporator where the air loses its water.

According to the invention, the resulting water collected in the water holding tank is used in a coffee maker, or some other water-consuming device that consumes a certain volume of water. An electronic controller may include a timer which opens the valve between the tank and the coffee maker when a preset time arrives at which the coffee maker is to make coffee. A user interface may include pushbuttons and/or dials, for example, which enable the user to set the volume of water that should be generated by a certain time of day, or within a certain period of time. Based on the user-provided desired water volume level and time parameters, the controller controls the speed of the fan motor and/or the speed of the compressor motor, thereby controlling the rate at which water is generated.

The tank may include a water level sensor that informs the controller of the current volume of water that is being held by the tank. Thus, feedback is provided to the controller so that the controller may speed up or slow down the fan motor and/or compressor motor as needed in order to generate the desired volume of water within the desired time frame.

For example, during use, a user may adjust a dial on the user interface that sets the desired amount of water to be generated at three cups. Thus, the coffee maker will be able to make about three cups of coffee. The user may also press pushbuttons on the user interface to set the time of day by which the three cups should be generated. For example, the user may enter 7 a.m. as the desired time for the three cups of coffee to be ready, and the controller may know that the current time is 11 p.m. the previous night. Accordingly, the controller may control the speed of the fan motor and/or compress motor such that three cups of water are produced by 6:50 a.m., thereby allowing ten minutes for the coffee maker to convert the water into coffee. The user may not desire that any more than the needed three cups of water be generated because of the needless extra energy consumption and/or additional noise generated by the fan and/or compressor that would be associated with making more than three cups of water. At 6:50 a.m., the controller may open the valve to cause the three cups of water to flow from the tank to the coffee maker.

The water level sensor may monitor the level of water in the tank throughout the night and communicate the water level to the controller so that the controller can speed up or slow down the fan motor and/or compressor motor in order to generate three and only three cups of water by 6:50 a.m. For example, if only one cup of water is in the tank at 3 a.m. (only about two cups would be generated by 6:50 a.m. at that rate), then the controller may speed up the fan motor and/or compressor motor in order to increase the rate of water generation. Conversely, if two cups of water are in the tank at 3 a.m. (about four cups would be generated by 6:50 a.m. at that rate), then the controller may slow down the fan motor and/or compressor motor in order to decrease the rate of water generation.

Instead of setting the time of day at which the desired volume of coffee is to be ready, the user may set the length of time in the future (e.g., eight hours) at which the desired volume of coffee is to be ready. Thus, the controller would not need to know the present time of day.

While this invention has been described as having an exemplary design, the present invention may be further modified within the spirit and scope of this disclosure. This application is therefore intended to cover any variations, uses, or adaptations of the invention using its general principles.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A water condensing apparatus for making a beverage comprising:
a water-generating module comprising a compressor and an evaporator to generate the water from atmospheric moisture via condensation;
a beverage-making module configured to receive the water and make the beverage;
a user interface enabling a user to specify a volume of water to be generated by the water-generating module within a period that is specifiable;
a controller in communication with the user interface and with the water generating-module, the controller being configured to control a rate of water generation based on the volume and the period specified using the user interface; and
a housing to at least partially enclose the water-generating module, beverage-making module, and the controller.

2. The apparatus of claim 1, wherein the water-generating module further comprises a fan to move air across the evaporator, the air being condensed to generate the water, wherein the fan is controllable by the controller.

3. The apparatus of claim 1, wherein the water generated by the water-generating module is held in a tank operatively connected to the beverage-making module by a valve configurable between an open state allowing the water to be received by the beverage-making module and a closed state substantially preventing the water from being received by the beverage-making module.

4. The apparatus of claim 3, wherein the tank further comprises a water level sensor to monitor a level of water in the tank.

5. The apparatus of claim 4, wherein the controller further comprises a timer and is in communication with the beverage-making module, wherein the controller analyzes signals from the timer and the water level sensor to control operation of the water-generating module and the beverage-making module.

6. The apparatus of claim 5, wherein the controller receives a time to start making the beverage from the user interface, wherein the controller calculates the period to operate the water-generating module to generate the volume of the water needed to make the beverage at the time minus the level of the water in the tank, and wherein the controller initiates operation of the water-generating module at a start time of approximately the time minus the period.

7. An apparatus for making a beverage comprising:
a water-generating module to generate water from atmospheric moisture;
a beverage-making module configured to receive the water and make the beverage;
a user interface enabling a user to specify a volume of the water to be generated by the water-generating module within a period that is specifiable; and
a controller in communication with the user interface and with the water generating-module, the controller being configured to control a rate of water generation based on the volume and the period specified using the user interface;
wherein the water generated by the water-generating module is held in a tank operatively connected to the beverage-making module by a valve configurable between an open state allowing the water to be received by the beverage-making module and a closed state substantially preventing the water from being received by the beverage-making module;
wherein the tank further comprises a water level sensor to monitor a level of the water in the tank;
wherein the controller further comprises a timer and is in communication with the beverage-making module, wherein the controller analyzes signals from the timer and the water level sensor to control operation of the water-generating module and the beverage-making module.

8. The apparatus of claim 7, wherein the water-generating module further comprises a compressor and an evaporator to generate the water via condensation.

9. The apparatus of claim 8, wherein the water-generating module further comprises a fan to move air across the evaporator, the air being condensed to generate the water, wherein the fan is controllable by the controller.

10. The apparatus of claim 7, wherein the controller receives a time to start making the beverage from the user interface, wherein the controller calculates the period to operate the water-generating module to generate the volume of the water needed to make the beverage at the time minus the level of the water in the tank, and wherein the controller initiates operation of the water-generating module at a start time of approximately the time minus the period.

11. The apparatus of claim 7, further comprising a housing to at least partially enclose the water-generating module, beverage making module, and the controller.

12. A method for making a beverage using a water condensing apparatus comprising the steps of:
(a) specifying a volume of water usable to make the beverage to be generated by a water-generating module within a period using a user interface;
(b) controlling the water-generating module using a controller to generate the water;
(c) condensing atmospheric moisture into the water using the water-generating module;
(d) receiving the water by a beverage-making module from the water-generating module; and
(e) controlling the beverage-making module using the controller to make the beverage;
wherein the controller is in communication with the user interface, water-generating module, and beverage-making module.

13. The method of claim 12, wherein the controller is configurable to control a rate of water generation based on the volume and the period specified using the user interface.

14. The method of claim 12, wherein the apparatus comprises a housing to at least partially enclose the water-generating module, beverage-making module, and the controller.

15. The method of claim 12, wherein the water-generating module comprises a compressor and an evaporator to generate water from atmospheric moisture via condensation.

16. The method of claim 15, wherein the water-generating module further comprises a fan that is controllable by the controller, and wherein step (c) further comprises the step of:
(i) moving air across the evaporator using the fan, the air being condensed to generate the water.

17. The method of claim 12, wherein the water generated by the water-generating module is held in a tank operatively connected to the beverage-making module by a valve configurable between an open state allowing the water to be received by the beverage-making module and a closed state substantially preventing the water from being received by the beverage-making module.

18. The method of claim 17, wherein the tank further comprises a water level sensor to monitor a level of water in the tank.

19. The method of claim 18, wherein the controller further comprises a timer and is in communication with the beverage-making module, and wherein step (b) further comprises the steps of:
(ii) analyzing a signals from the timer and the water level sensor using the controller to control operation of the water-generating module; and
(iii) analyzing a signals from the timer and the water level sensor using the controller to control operation of the beverage-making module.

20. The method of claim 18, wherein the controller further comprises a timer and is in communication with the beverage-making module, and wherein step (b) further comprises the steps of:
(iv) receiving a time by the controller to start making the beverage from the user interface,
(v) calculating the period by the controller to operate the water-generating module to generate the volume of the water needed to make the beverage at the time;
(vi) calculating a start time to be a difference between the time and the period; and
(vii) initiating operation of the water-generating module by the controller at approximately the start time.
